(19) United States
(12) Patent Application Publication
(10) Pub. No.: US 2014/0037850 A1
(43) Pub. Date: Feb. 6, 2014

(54) CORROSION AND WEAR RESISTANT ORGANIC COATINGS

(71) Applicants: Donald Joseph Buckley, JR., Schenectady, NY (US); Lawrence Bernard Kool, Clifton Park, NY (US); Raul Basilio Rebak, Schenectady, NY (US); Dennis Michael Gray, Delanson, NY (US); Brent Allen Clothier, Clifton Park, NY (US); Grzegorz Jan Kusinski, Houston, TX (US)

(72) Inventors: Donald Joseph Buckley, JR., Schenectady, NY (US); Lawrence Bernard Kool, Clifton Park, NY (US); Raul Basilio Rebak, Schenectady, NY (US); Dennis Michael Gray, Delanson, NY (US); Brent Allen Clothier, Clifton Park, NY (US); Grzegorz Jan Kusinski, Houston, TX (US)

(73) Assignee: GENERAL ELECTRIC COMPANY, Schenectady, NY (US)

(21) Appl. No.: 13/596,399

(22) Filed: Aug. 28, 2012

Related U.S. Application Data
(60) Provisional application No. 61/679,892, filed on Aug. 6, 2012.

(51) Int. Cl. B05D 3/02; B05D 3/12

(52) U.S. Cl. 427/290; 427/386

(57) ABSTRACT

The present invention provides a method of protecting refinery equipment, the method comprising: (a) applying an uncured organic coating comprising a curable epoxy phenol novolac resin and a curing agent comprising a vicinal primary diamine moiety to a surface of refinery equipment susceptible to corrosion and/or wear; and (b) curing the uncured coating to form a cured coating having a viscosity of at least 2,000,000 centipoise; wherein the uncured organic coating has a viscosity of less than 500,000 centipoise, and wherein the uncured coating is substantially free of components comprising secondary and tertiary amine groups, and wherein the uncured coating is characterized by a latent viscosity of at least 2,000,000 when cured for 1 hour at 50° C.

### BACKGROUND

The present invention relates to protecting equipment surfaces from corrosion and other damage. In particular the present invention provides methods and compositions suitable for producing protective organic coatings.

Surfaces of equipment used in crude oil refining are frequently made of steel and are subject to the effects of corrosion and wear. Harmful corrosive species abound in the chemically rich environment of a typical refining operation. Gases capable of destroying the structural integrity of equipment, such as hydrogen sulfide and hydrogen are common constituents of process fluids present in refining operations. Moreover, a variety of non-gaseous corrosive species such as naphthenic acids, sulfonic acids and halides are frequently present and may damage refinery equipment surfaces. Further, surfaces may be damaged by the scouring effects of particulate matter present in a variety of refinery process fluids.

Heat affected portions of refinery equipment such as weld lines and associated heat affected zones around weld lines have proven to be especially sensitive to the corrosive effects of harmful species such as hydrogen sulfide and naphthenic acids. Because of this, there has been sustained interest in the development of protective coatings for surfaces in refinery vessels and conduits containing such weld lines. Despite the large number of solutions that have been proposed, further improvements are needed, particularly in the development of methods for the efficient deployment of such protective coatings.

The present invention provides a number of useful enhancements to the deployment of protective coatings for refinery equipment.

### BRIEF DESCRIPTION

In one embodiment, the present invention provides a method of protecting refinery equipment, the method comprising: (a) applying an uncured organic coating comprising a curable epoxy phenol novolac resin and a curing agent comprising a vicinal primary diamine moiety to a surface of refinery equipment susceptible to corrosion; and (b) curing the uncured coating to form a cured coating having a viscosity of at least 2,000,000 centipoise; wherein the uncured organic coating has a viscosity of less than 500,000 centipoise, and wherein the uncured coating is substantially free of components comprising secondary and tertiary amine groups, and wherein the uncured coating is characterized by a latent viscosity of at least 2,000,000 when cured for 1 hour at 50° C.

In an alternate embodiment, the present invention provides a method of protecting refinery equipment, the method comprising: (a) applying an uncured organic coating to a surface of refinery equipment susceptible to corrosion, said uncured organic coating comprising a curable liquid epoxy phenol novolac resin and a curing agent comprising a vicinal primary diamine having structure I

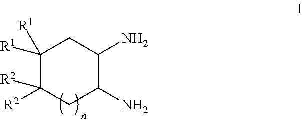

wherein n is 0, 1, 2, or 3 and R¹ and R² are independently at each occurrence hydrogen, a primary amine moiety, a C₁-C₁₀ aliphatic radical, a C₄-C₁₀ cycloaliphatic radical, a C₆-C₁₀ aromatic radical, or R¹ and R² may together form a second ring; and (b) curing the uncured coating at a temperature in a range from about 20° C. to about 60° C. to form a cured coating having a viscosity of at least 2,000,000 centipoise; wherein the uncured coating is substantially free of secondary and tertiary amine groups, and wherein the uncured coating is characterized by a latent viscosity of at least 2,000,000 when cured for 1 hour at 50° C.

In yet another embodiment, the present invention provides a method of protecting refinery equipment comprising: (a) applying an uncured organic coating to a surface of refinery equipment susceptible to corrosion, said uncured organic coating comprising a curable liquid epoxy phenol novolac resin and a curing agent comprising structure II

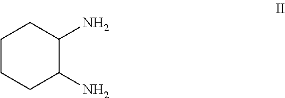

wherein said surface comprises a weld line and is characterized by a mean square surface roughness of at least 3 thousandths of an inch; and (b) curing the uncured coating at a temperature in a range from about 20° C. to about 60° C. to form a cured coating having a viscosity of at least 2,000,000 centipoise; wherein the uncured coating is substantially free of secondary and tertiary amine groups, and wherein the uncured coating is characterized by a latent viscosity of at least 2,000,000 when cured for 1 hour at 50° C.

In yet still another embodiment, the present invention provides a method of protecting a refinery vessel, the method comprising: (a) grit blasting a refinery vessel surface comprising a weld line to achieve a root mean square surface roughness of at least 3 thousandths of an inch; (b) combining a curable liquid epoxy novolac resin with a curing agent comprising structure II

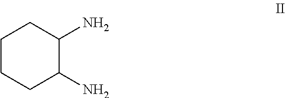

to provide an uncured organic coating having a viscosity of less than 200,000 centipoise; (c) applying the uncured coating to the refinery vessel surface grit blasted in step (a); and (d) curing the uncured coating at a temperature in a range from about 40° C. to about 60° C. over a time period ranging from about 1 hour to about 4 hours to form a cured coating having a viscosity of at least 2,000,000 centipoise; wherein the uncured coating is substantially free of secondary and tertiary amine groups, and wherein the uncured coating is characterized by a latent viscosity of at least 2,000,000 when cured for 1 hour at 50° C.

### BRIEF DESCRIPTION OF THE DRAWING FIGURES

Various features, aspects, and advantages of the present invention will become better understood when the following detailed description is read with reference to the accompanying drawings in which like characters may represent like parts throughout the drawings. Unless otherwise indicated, the drawings provided herein are meant to illustrate key inventive features of the invention. These key inventive features are believed to be applicable in a wide variety of systems which comprise one or more embodiments of the invention. As such, the drawings are not meant to include all conventional features known by those of ordinary skill in the art to be required for the practice of the invention.

FIG. 1 illustrates refinery equipment comprising surfaces which may be protected according to one or more embodiments of the present invention.

FIG. 2 illustrates a method of protecting equipment according to one or more embodiments of the present invention

FIG. 3A illustrates a portion of equipment to be protected according to one or more embodiments of the present invention.

FIG. 3B illustrates a portion of equipment protected by a coating applied according to one or more embodiments of the present invention.

### DETAILED DESCRIPTION

In the following specification and the claims, which follow, reference will be made to a number of terms, which shall be defined to have the following meanings.

The singular forms “a”, “an”, and “the” include plural referents unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

As used herein, the term “aromatic radical” refers to an array of atoms having a valence of at least one comprising at least one aromatic group. The array of atoms having a valence of at least one comprising at least one aromatic group may include heteroatoms such as nitrogen, sulfur, selenium, silicon and oxygen, or may be composed exclusively of carbon and hydrogen. As used herein, the term “aromatic radical” includes but is not limited to phenyl, pyridyl, furanyl, thienyl, naphthyl, phenylene, and biphenyl radicals. As noted, the aromatic radical contains at least one aromatic group. The aromatic group is invariably a cyclic structure having 4n+2 “delocalized” electrons where “n” is an integer equal to 1 or greater, as illustrated by phenyl groups (n=1), thienyl groups (n=1), furanyl groups (n=1), naphthyl groups (n=2), azulenyl groups (n=2), anthraceneyl groups (n=3) and the like. The aromatic radical may also include nonaromatic components. For example, a benzyl group is an aromatic radical which comprises a phenyl ring (the aromatic group) and a methylene group (the nonaromatic component). Similarly a tetrahydronaphthyl radical is an aromatic radical comprising an aromatic group (C₆H₃) fused to a nonaromatic component —(CH₂)₄—. For convenience, the term “aromatic radical” is defined herein to encompass a wide range of functional groups such as alkyl groups, alkenyl groups, alkynyl groups, haloalkyl groups, haloaromatic groups, conjugated dienyl groups, alcohol groups, ether groups, aldehyde groups, ketone groups, carboxylic acid groups, acyl groups (for example carboxylic acid derivatives such as esters and amides), amine groups, nitro groups, and the like. For example, the 4-methylphenyl radical is a C₇ aromatic radical comprising a methyl group, the methyl group being a functional group which is an alkyl group. Similarly, the 2-nitrophenyl group is a C₆ aromatic radical comprising a nitro group, the nitro group being a functional group. Aromatic radicals include halogenated aromatic radicals such as 4-trifluoromethylphenyl, hexafluoroisopropylidenebis(4-phen-1-yloxy) (i.e., —OPhC(CF₃)₂PhO—), 4-chloromethylphen-1-yl, 3-trifluorovinyl-2-thienyl, 3-trichloromethylphen-1-yl (i.e., 3-CCl₃Ph-), 4-(3-bromoprop-1-yl)phen-1-yl (i.e., 4-BrCH₂CH₂CH₂Ph-), and the like. Further examples of aromatic radicals include 4-allyloxyphen-1-oxy, 4-aminophen-1-yl (i.e., 4-H₂NPh-), 3-aminocarbonylphen-1-yl (i.e., NH₂COPh-), 4-benzoylphen-1-yl, dicyanomethylidenebis(4-phen-1-yloxy) (i.e., —OPhC(CN)₂PhO—), 3-methylphen-1-yl, methylenebis(4-phen-1-yloxy) (i.e., —OPhCH₂PhO—), 2-ethylphen-1-yl, phenylethenyl, 3-formyl-2-thienyl, 2-hexyl-5-furanyl, hexamethylene-1,6-bis(4-phen-1-yloxy) (i.e., —OPh(CH₂)₆PhO—), 4-hydroxymethylphen-1-yl (i.e., 4-HOCH₂Ph-), 4-mercaptomethylphen-1-yl (i.e., 4-HSCH₂Ph-), 4-methylthiophen-1-yl (i.e., 4-CH₃SPh-), 3-methoxyphen-1-yl, 2-methoxycarbonylphen-1-yloxy (e.g., methyl salicyl), 2-nitromethylphen-1-yl (i.e., 2-NO₂CH₂Ph), 3-trimethylsilylphen-1-yl, 4-t-butyldimethylsilylphen-1-yl, 4-vinylphen-1-yl, vinylidenebis(phenyl), and the like. The term “a C₃-C₁₀ aromatic radical” includes aromatic radicals containing at least three but no more than 10 carbon atoms. The aromatic radical 1-imidazolyl (C₃H₂N₂—) represents a C₃ aromatic radical. The benzyl radical (C₇H₇—) represents a C₇ aromatic radical.

As used herein the term “cycloaliphatic radical” refers to a radical having a valence of at least one, and comprising an array of atoms which is cyclic but which is not aromatic. As defined herein a “cycloaliphatic radical” does not contain an aromatic group. A “cycloaliphatic radical” may comprise one or more noncyclic components. For example, a cyclohexylmethyl group (C₆H₁₁CH₂—) is a cycloaliphatic radical which comprises a cyclohexyl ring (the array of atoms which is cyclic but which is not aromatic) and a methylene group (the noncyclic component). The cycloaliphatic radical may include heteroatoms such as nitrogen, sulfur, selenium, silicon and oxygen, or may be composed exclusively of carbon and hydrogen. For convenience, the term “cycloaliphatic radical” is defined herein to encompass a wide range of functional groups such as alkyl groups, alkenyl groups, alkynyl groups, haloalkyl groups, conjugated dienyl groups, alcohol groups, ether groups, aldehyde groups, ketone groups, carboxylic acid groups, acyl groups (for example carboxylic acid derivatives such as esters and amides), amine groups, nitro groups, and the like. For example, the 4-methylcyclopent-1-yl radical is a C₆ cycloaliphatic radical comprising a methyl group, the methyl group being a functional group which is an alkyl group. Similarly, the 2-nitrocyclobut-1-yl radical is a C₄ cycloaliphatic radical comprising a nitro group, the nitro group being a functional group. A cycloaliphatic radical may comprise one or more halogen atoms which may be the same or different. Halogen atoms include, for example; fluorine, chlorine, bromine, and iodine. Cycloaliphatic radicals comprising one or more halogen atoms include 2-trifluoromethylcyclohex-1-yl, 4-bromodifluoromethylcyclooct-1-yl, 2-chlorodifluoromethylcyclohex-1-yl, hexafluoroisopropylidene-2,2-bis(cyclohex-4-yl) (i.e., —C₆H₁₀C(CF₃)₂ C₆H₁₀—), 2-chloromethylcyclohex-1-yl, 3-difluoromethylenecyclohex-1-yl, 4-trichloromethylcyclohex-1-yloxy, 4-bromodichloromethylcyclohex-1-ylthio, 2-bromoethylcyclopent-1-yl, 2-bromopropylcyclohex-1-yloxy (e.g., CH₃CHBrCH₂C₆H₁₀O—), and the like. Further examples of cycloaliphatic radicals include 4-allyloxycyclohex-1-yl, 4-aminocyclohex-1-yl (i.e., H₂C₆H₁₀—), 4-aminocarbonylcyclopent-1-yl (i.e., NH₂COC₅H₈—), 4-acetyloxycyclohex-1-yl, 2₉2-dicyanoisopropylidenebis(cyclohex-4-yloxy) (i.e., −OC₆H₁₀C(CN)₂C₆H₁₀O—), 3-methylcyclohex-1-yl, methylenebis(cyclohex-4-yloxy) (i.e., —OC₆H₁₀CH₂C₆H₁₀O—), 1-ethylcyclobut-1-yl, cyclopropylethenyl, 3-formyl-2-terahydrofuranyl, 2-hexyl-5-tetrahydrofuranyl, hexamethylene-1,6-bis(cyclohex-4-yloxy) (i.e., —OC₆H₁₀(CH₂)₆C₆H₁₀O—), 4-hydroxymethylcyclohex-1-yl (i.e., 4-HOCH₂C₆H₁₀—), 4-mercaptomethylcyclohex-1-yl (i.e., 4-HSCH₂C₆H₁₀—), 4-methylthiocyclohex-1-yl (i.e., 4-CH₃SC₆H₁₀—), 4-methoxycyclohex-1-yl, 2-methoxycarbonylcyclohex-1-yloxy (2-CH₃OCOC₆H₁₀O—), 4-nitromethylcyclohex-1-yl (i.e., NO₂CH₂C₆H₁₀—), 3-trimethylsilylcyclohex-1-yl, 2-t-butyldimethylsilylcyclopent-1-yl, 4-trimethoxysilylethylcyclohex-1-yl (e.g., (CH₃O)₃SiCH₂CH₂C₆H₁₀—), 4-vinylcyclohexen-1-yl, vinylidenebis(cyclohexyl), and the like. The term “a C₃-C₁₀ cycloaliphatic radical” includes cycloaliphatic radicals containing at least three but no more than 10 carbon atoms. The cycloaliphatic radical 2-tetrahydrofuranyl (C₄H₇O—) represents a C₄ cycloaliphatic radical. The cyclohexylmethyl radical (C₆H₁₁CH₂—) represents a C₇ cycloaliphatic radical.

As used herein the term “aliphatic radical” refers to an organic radical having a valence of at least one consisting of a linear or branched array of atoms which is not cyclic. Aliphatic radicals are defined to comprise at least one carbon atom. The array of atoms comprising the aliphatic radical may include heteroatoms such as nitrogen, sulfur, silicon, selenium and oxygen or may be composed exclusively of carbon and hydrogen. For convenience, the term “aliphatic radical” is defined herein to encompass, as part of the “linear or branched array of atoms which is not cyclic” a wide range of functional groups such as alkyl groups, alkenyl groups, alkynyl groups, haloalkyl groups, conjugated dienyl groups, alcohol groups, ether groups, aldehyde groups, ketone groups, carboxylic acid groups, acyl groups (for example carboxylic acid derivatives such as esters and amides), amine groups, nitro groups, and the like. For example, the 4-methylpent-1-yl radical is a C₆ aliphatic radical comprising a methyl group, the methyl group being a functional group which is an alkyl group. Similarly, the 4-nitrobut-1-yl group is a C₄ aliphatic radical comprising a nitro group, the nitro group being a functional group. An aliphatic radical may be a haloalkyl group which comprises one or more halogen atoms which may be the same or different. Halogen atoms include, for example; fluorine, chlorine, bromine, and iodine. Aliphatic radicals comprising one or more halogen atoms include the alkyl halides trifluoromethyl, bromodifluoromethyl, chlorodifluoromethyl, hexafluoroisopropylidene, chloromethyl, difluorovinylidene, trichloromethyl, bromodichloromethyl, bromoethyl, 2-bromotrimethylene (e.g., —CH₂CHBrCH₂—), and the like. Further examples of aliphatic radicals include allyl, aminocarbonyl (i.e., —CONH₂), carbonyl, 2,2-dicyanoisopropylidene (i.e., —CH₂C(CN)₂CH₂—)₉ methyl (i.e., —CH₃), methylene (i.e., —CH₂—), ethyl, ethylene, formyl (i.e., —CHO), hexyl, hexamethylene, hydroxymethyl (i.e., —CH₂OH), mercaptomethyl (i.e., —CH₂SH), methylthio (i.e., —SCH₃), methylthiomethyl (i.e., —CH₂SCH₃), methoxy, methoxycarbonyl (i.e., CH₃OCO—), nitromethyl (i.e., —CH₂NO₂), thiocarbonyl, trimethylsilyl (i.e., (CH₃)₃Si—), t-butyldimethylsilyl, 3-trimethyoxysilylpropyl (i.e., (CH₃O)₃SiCH₂CH₂CH₂—), vinyl, vinylidene, and the like. By way of further example, a C₁-C₁₀ aliphatic radical contains at least one but no more than 10 carbon atoms. A methyl group (i.e., CH₃—) is an example of a C₁ aliphatic radical. A decyl group (i.e., CH₃(CH₂)₉—) is an example of a C₁₀ aliphatic radical.

As noted, in one embodiment, the present invention provides a method of protecting refinery equipment, the method comprising the following steps: (a) applying an uncured organic coating comprising a curable epoxy phenol novolac resin and a curing agent comprising a vicinal primary diamine moiety to a surface of a refinery component susceptible to corrosion; and (b) curing the uncured coating to form a cured coating having a viscosity of at least 2,000,000 centipoise, wherein the uncured organic coating has a viscosity of less than 500,000 centipoise, and wherein the uncured coating is substantially free of components comprising secondary and tertiary amine groups, and wherein the uncured coating is characterized by a latent viscosity of at least 2,000,000 when cured for 1 hour at 50° C.

As noted, the surface to which the uncured organic coating is applied may be any surface susceptible to corrosion and/or wear for which protection is desired. Such surfaces are common in components of refinery equipment in which surfaces may be exposed to a variety of chemical species harmful to the structural integrity of the surface and ultimately the equipment. Such harmful species include hydrogen sulfide (H₂S), halide ions, steam, hydrogen gas, carboxylic acids, sulfonic acids and the like. Refinery equipment includes vessels, flow reactors, pipes, heat exchangers, distillation towers, and like equipment.

Typically, the surfaces to be protected are interior surfaces in refinery equipment which are exposed to process fluids encountered in crude oil refining. Because accessibility of these surfaces to men and equipment is frequently severely limited, improvements in the longevity of refinery equipment through the use of protective coatings installed during equipment manufacture may be especially desirable. In one or more embodiments, therefore, the method of the present invention is practiced during the manufacture of refinery equipment and prior to the actual installation and use of the equipment in a refinery. In one or more alternate embodiments, the method of the present invention is practiced on refinery equipment after having been in service as part of a refinery service regimen.

In one or more embodiments the surface to be protected comprises a weld line and an associated heat affected zone (at times referred to as a “HAZ”). Weld lines in metals are notoriously sensitive to corrosion and other stresses and frequently represent the weakest structural feature of refinery equipment. The present invention provides methods of shielding weld lines and their associated heat affected zones from the effects of corrosive species present in refinery operations, for example hydrogen sulfide, naphthenic acids, and sulfonic acids.

In one or more embodiments, the surface to be protected is subjected to one or more surface cleaning steps prior to applying the uncured organic coating. This surface cleaning step is optional but may improve the performance of the cured coating. Various cleaning steps which may be used include grit blasting, organic solvent degreasing, aqueous washing, steam cleaning, and like techniques. In one or more embodiments, the surface to be protected is subjected to a cleaning protocol comprising grit blasting. In one embodiment, the surface to be protected is subjected to a cleaning step comprising grit blasting the surface to a white metal finish having a root mean square surface roughness of at least 3 thousandths of an inch. In one or more embodiments the surface to be protected is subjected to a cleaning step comprising grit blasting the surface with alumina particles to a white metal finish having a root mean square surface roughness of at least 3 thousandths of an inch. In one or more embodiments the alumina employed is 24-grit alumina.

The curable epoxy phenol novolac resin component of the uncured organic coating is typically a liquid resin prepared by reaction of a phenolic novolac with an epoxide containing moiety such as epichlorohydrin. A wide variety of epoxy novolac resins suitable for use according to one or more embodiments of the present invention are available commercially, for example the BELZONA series of resins available through Belzona Inc., (Miami, Fla.), the EPON series of resins available through Momentive Specialty Chemicals (Houston, Tex.), the D.E.N. series of resins available from DOW Chemicals (USA), and the EPOTEC series of resins available through Aditya Birla Chemicals (Thailand), among others. The curable epoxy phenol novolac resin may contain an inorganic filler, as in for example BELZONA 1591 which comprises 10-30 percent by weight of an epoxy phenol novolac resin (CAS No. 28064-14-4) together with a ceramic filler, and have a paste-like appearance.

In one aspect, the uncured organic coating used according to one or more embodiments of the present invention comprises a filler. In an alternate aspect, the uncured organic coating used according to one or more embodiments of the present invention does not contain a filler. In yet a further aspect, the uncured organic coating is substantially free of filler, meaning that it contains less than five percent by weight filler. Suitable fillers include metal oxides, various minerals, mixtures of metal oxides, ceramics, clays, nanoclays, organic nanoclays, organic particles such as PTFE, and silica, among others. The foregoing list is meant to illustrate the fact that a variety of filled uncured organic coatings are believed to be suitable for use according to one or more embodiments of the present invention. In one or more embodiments, the uncured organic coating comprises a solid filler which is capable of reacting with or neutralizing harmful species such as hydrogen sulfide, for example zinc oxide.

The uncured organic coating which is applied to a surface of refinery equipment susceptible to corrosion further comprises a curing agent which comprises a vicinal primary diamine moiety, and further, the curing agent is substantially free of components comprising secondary and tertiary amine groups. It is believed that because of its vicinal primary diamine moiety structure, the curing agent is less reactive under ambient conditions with the epoxy groups of the curable epoxy phenol novolac resin than are curing agents comprising amine groups which are primary but not vicinal, for example as is the case of the curing agent DETA (Structure 1 below).

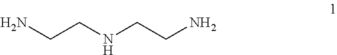

Lower reactivity of the curing agent with the epoxy groups of the epoxy phenol novolac resin under ambient conditions, as when preparing a batch of an uncured organic coating comprising a curable epoxy phenol novolac resin and a curing agent comprising a vicinal primary diamine moiety, results in improved pot life of the uncured coating. Thus, the rate at which the curing agent comprising a vicinal primary diamine moiety reacts with and promotes the polymerization of the epoxy phenol novolac resin is sufficiently low such that the physical properties of the uncured organic coating (e.g. viscosity, color, and chemical structure) do not change greatly over the course of 24 hours (as measured from the time the curing agent and the curable epoxy phenol novolac resin are blended) when the uncured organic coating is maintained under mild ambient conditions (under 20° C. and less than 70% humidity). This allows a single batch of an uncured organic coating to be prepared in a mixing vessel, for example, and a portion of the batch to be applied to a surface of a refinery equipment component to form an uncured coating on the surface, curing the uncured coating at a slightly elevated temperature relative to the ambient temperature, cooling the component, and then repeating the foregoing steps on the same component using the same batch of uncured organic coating. Those of ordinary skill in the art will appreciate that such on-demand curing will allow for a longer useful life of the uncured organic coating as well as incidental benefits such as greater ease in the cleaning of vessels used to prepare the uncured organic coating, since the uncured organic coating may be retained in a substantially un-polymerized and soluble state if maintained under mild ambient conditions.

As noted, in one or more embodiments, the uncured organic coating has a viscosity of less than 500,000 centipoise. In one or more alternate embodiments the uncured organic coating has a viscosity of less than 200,000 centipoise. In yet additional embodiments the uncured organic coating has a viscosity of less than 100,000 centipoise.

As noted, the uncured organic coating is characterized by a latent viscosity of at least 2,000,000 centipoise when cured for 1 hour at 50° C. Thus, upon curing for one hour at 50° C., the uncured organic coating used according to one or more embodiments of the present invention and having a viscosity of less than 500,000 centipoise is transformed into a cured organic coating having a viscosity of at least 2,000,000 centipoise.

The latent viscosity of the uncured organic coating may be controlled by adjusting the relative amounts of the curable epoxy phenol novolac resin and the curing agent comprising a vicinal primary diamine moiety. In one embodiment, the uncured organic coating is characterized by a weight ratio of from about three parts by weight to about twelve parts by weight of the curable epoxy phenol novolac resin to one part by weight of the curing agent. Typically, such uncured organic coatings may be prepared by combining and mechanically mixing a first component curable epoxy phenol novolac resin and a second component curing agent comprising a vicinal primary diamine moiety in a weight ratio of from about three parts by weight to about twelve parts by weight of the curable epoxy phenol novolac resin to one part by weight of the curing agent. In one or more embodiments, the first component curable epoxy phenol novolac resin and the second component curing agent comprising a vicinal primary diamine moiety are separate components of a coating kit which may be combined together to provide the uncured organic coating as needed.

In one embodiment, the uncured organic coating is sufficiently fluid to be applied to a surface using a brush. Such application of the uncured organic coating to the surface is at times herein referred to as a brush-on application of the uncured organic coating. In one or more embodiments, the uncured organic coating is applied to the surface to be protected by spray coating the surface. Such application of the uncured organic coating is at times herein referred to as a spray-on application of the uncured organic coating.

In one or more embodiments, the uncured organic coating comprises a solvent, for example acetone, cyclohexanone, methyl ethyl ketone, butyrolactone, and like solvents known to those of ordinary skill in the art. A solvent or a mixture of solvents may be used to decrease the viscosity of the uncured organic coating so that it may be more conveniently applied to the surface to be protected. In one or more alternate embodiments, the uncured organic coating is solvent free.

In one or more embodiments of the present invention, curing of the uncured organic coating is carried out by heating the coating on the surface to a temperature in a range between about 20° C. and about 80° C. In one embodiment, curing of the uncured organic coating is carried out at a temperature in a range from about 20° C. to about 60° C. In an alternate embodiment, curing of the uncured organic coating is carried out at a temperature in a range from about 30° C. to about 60° C. In yet another embodiment, curing of the uncured organic coating is carried out at a temperature in a range from about 40° C. to about 60° C.

Heating of the uncured organic coating to transform it into a cured organic coating may be effected by a variety of suitable heating means. In one or more embodiments, the uncured organic coating is heated by passing a stream of heated gas over the uncured organic coating disposed on the surface to be protected. A variety of gases are suitable, including air, nitrogen-enriched air, and nitrogen. While relatively inert gases such as nitrogen-enriched air and nitrogen may at times be preferred, in some embodiments one or more process gases present in a refinery environment may also be used to heat and cure the uncured organic coating. A wide variety of alternate methods are known to those of ordinary skill in the art for heating the uncured organic coating disposed upon a surface to transform it into a cured organic coating. Such alternate methods include electrical heating, passive convection heating, passive conduction heating, photonic heating, microwave heating, and like heating methods.

In one or more embodiments, curing of the uncured organic coating is carried out by contacting the uncured coating disposed on the surface to be protected with a stream of air having a temperature in a range from about 30° C. to about 60° C. In one or more embodiments the curing time may range from about 1 to about 8 hours. In one or more alternate embodiments the curing time may range from about 1 to about 3 hours.

The uncured organic coating is typically applied in an amount corresponding to an average coating thickness in the cured state of from about twenty thousandths of an inch to about thirty thousandths of an inch. Thus, in one or more embodiments the cured coating is characterized by an average thickness in a range from about twenty thousandths of an inch to about thirty thousandths of an inch.

Suitable curing agents for use according to one or more embodiments of the present invention include vicinal primary diamines having structure I

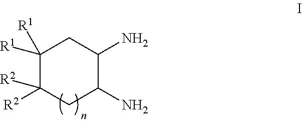

wherein n is 0, 1, 2, or 3 and R¹ and R² are independently at each occurrence hydrogen, a primary amine moiety, a C₁-C₁₀ aliphatic radical, a C₄-C₁₀ cycloaliphatic radical, a C₆-C₁₀ aromatic radical, or R¹ and R² may together form a second ring.

Table I below illustrates specific examples of vicinal primary diamine compounds represented by generic formula I.

| Entry | Structure | R¹ | R¹ | R² | R² | n |
|---|---|---|---|---|---|---|
| Ia | 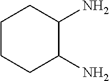 | H | H | H | H | 1 |
| Ib | 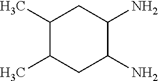 | CH₃ | H | CH₃ | H | 1 |
| Ic | 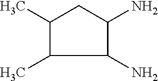 | CH₃ | H | CH₃ | H | 0 |
| Id | 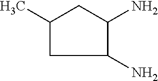 | CH₃ | H | H | H | 0 |
| Ie | 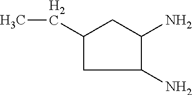 | Et | H | H | H | 0 |
| If | 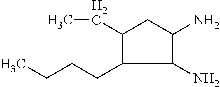 | Et | H | Bu | H | 0 |
| Ig | 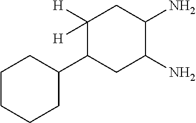 | H | H | C₆* | H | 1 |
| Ih | 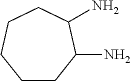 | H | H | H | H | 2 |
| Ii | 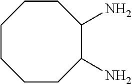 | H | H | H | H | 3 |
| Ij | 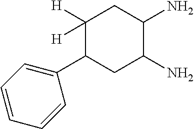 | H | H | Ph | H | 1 |
| Ik | 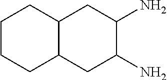 | (CH₂)₂ | H | (CH₂)₂ | H | 1 |

*C₆ = cyclohexyl

In one aspect, the curing agent used according to one or more embodiments of the present invention has structure II, which is also shown in Table I as structure Ia and may at times herein be referred to as cyclohexane diamine and abbreviated as CHDA. Those of ordinary skill in the art will understand that structure (II/Ia) and

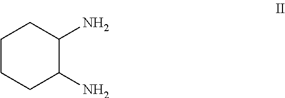

structures Ib-Ik of Table I are meant to represent the various possible configurations of the amine groups as well as other stereo centers which may be present. Thus, for example, structure II/Ia is meant to represent CHDA in which the amine groups are disposed trans to one another on the cyclohexane ring (trans-CHDA), as well as the alternate configuration in which the amine groups are disposed cis to one another on the cyclohexane ring (cis-CHDA). Thus, in one embodiment of the present invention, the curing agent comprises trans-CHDA. In an alternate embodiment, the curing agent comprises cis-CHDA. In yet another embodiment, the curing agent comprises both cis-CHDA and trans CHDA.

In one or more embodiments of the present invention, the curing agent employed is characterized by a closed cup flash point temperature of 70° C. or higher in a standard test method such as the ASTM D93-11 test method. Typically, curing of the uncured organic coating should be carried out at a temperature significantly below the closed cup flash point temperature unless appropriate measures are taken to assure that curing is carried out in an inert atmosphere. Those of ordinary skill in the art will understand that the curing agents Ib-Ik will have closed cup flash point temperatures which are higher than the closed cup flash point temperature of curing agent Ia which is about 70° C., with possible exceptions to this rule being found for compounds represented by structures Id and Ic.

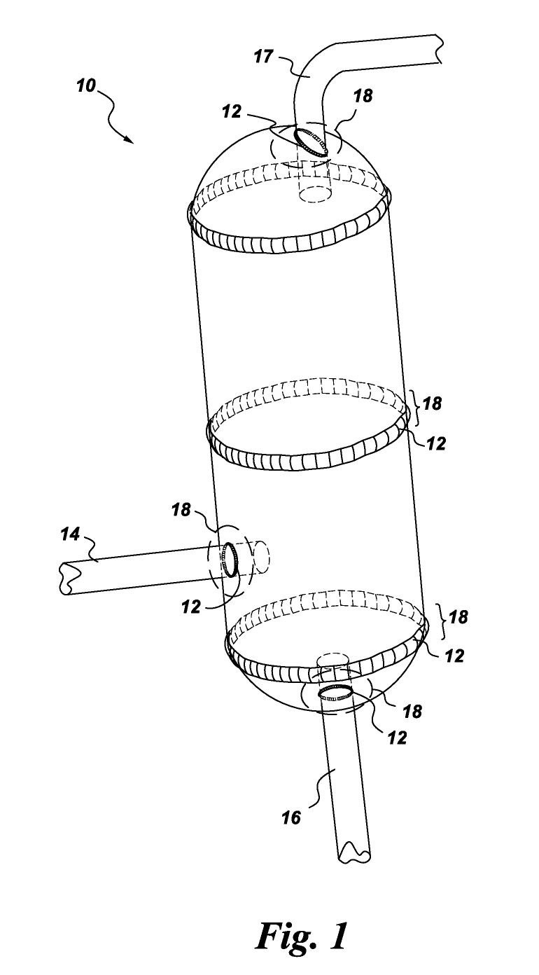

Turning now to the figures, FIG. 1 represents a refinery vessel 10 comprising weld lines 12 a vessel fluid inlet 14 and vessel fluid outs 16 and 17 and heat affected zones 18 associated with each of weld lines 12. In one or more embodiments, weld lines 12 and the corresponding heat affected zones may be protected using one or more embodiments of the present invention.

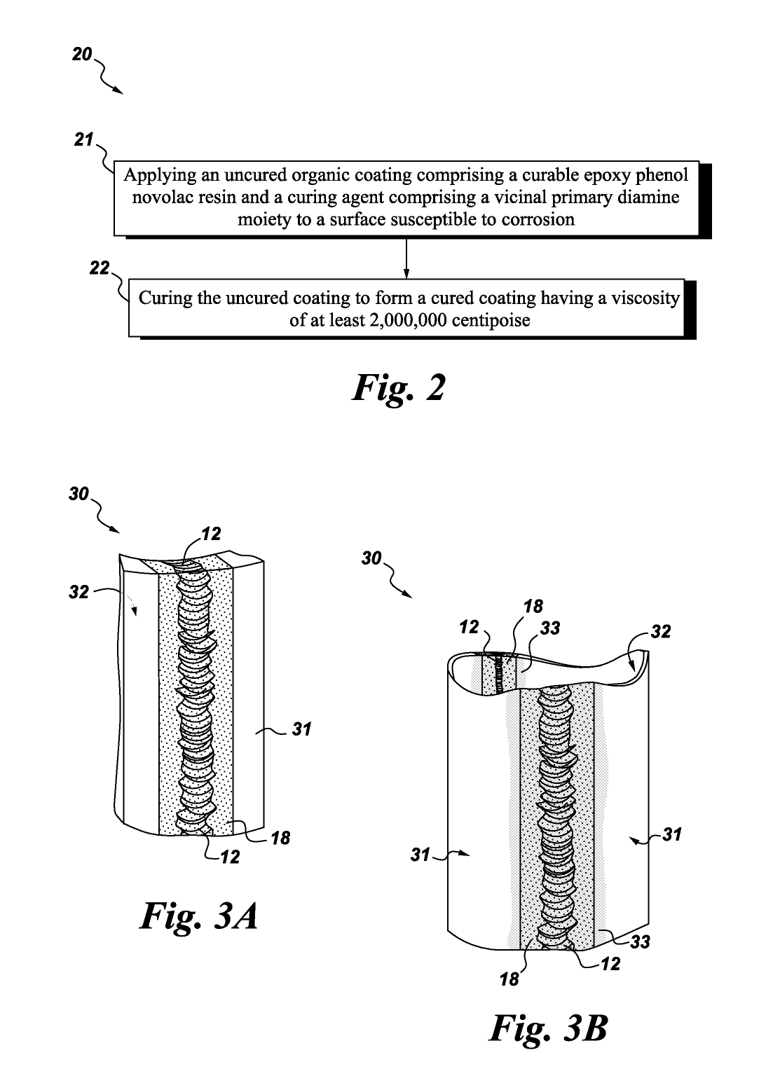

FIG. 2 illustrates schematically a method 20 provided by the present invention. In a first step 21 an uncured organic coating is applied to a surface of equipment requiring protection wherein the uncured organic coating comprises a curable epoxy phenol novolac resin and a curing agent comprising a vicinal primary diamine moiety. In a second step 22 the uncured coating disposed upon the equipment surface is cured to form a cured coating having a viscosity of at least 2,000,000 centipoise; wherein the uncured organic coating has a viscosity of less than 500,000 centipoise, and wherein the uncured coating is substantially free of components comprising secondary and tertiary amine groups, and wherein the uncured coating is characterized by a latent viscosity of at least 2,000,000 centipoise when cured for 1 hour at 50° C.

FIG. 3A illustrates a portion 30 of a refinery vessel having a vessel wall exterior surface 31 and a vessel wall interior surface 32 requiring protection. A weld line 12 traverses the vessel from the exterior surface to the interior surface. Each surface is said to comprise the weld line and its associated heat affected zone 18.

FIG. 3B illustrates a portion 30 of a refinery vessel having a vessel wall exterior surface 31 and a vessel wall interior surface 32 requiring protection. Weld lines 12 traverse the vessel from the vessel wall exterior surface to the vessel wall interior surface. An uncured organic coating 33 comprising an epoxy phenol novolac resin and a curing agent comprising a vicinal primary diamine moiety is shown disposed upon portions of the interior surface 32 comprising the weld lines 12 and the heated affected zones 18 associated with each of the weld lines. The uncured organic coating 33 has a viscosity of less than 500,000 centipoise, is substantially free of components comprising secondary and tertiary amine groups, and is characterized by a latent viscosity of at least 2,000,000 centipoise when cured for 1 hour at 50° C. In the embodiment shown, at least one of the weld lines and its associated heat affected zone is coated with uncured organic coating 33 on both the exterior surface 31 and the interior surface 32.

### Experimental Part

### (1) Preparation of Uncured Coating Formulations

### Method 1 BELZONA® Control Coating Formulation

The BELZONA® control uncured coating formulation was prepared according to manufacturer's instructions by blending, using hand stirring at 20 degrees Centigrade, the dual amine curing agent (Part B of the manufacturer's kit) into the BELZONA B1591 resin/filler blend (Part A of the manufacturer's kit) in a ratio of 22.3 parts resin/filler to 1 part dual amine by weight, until a uniform mixture was attained, as judged by the consistent viscosity throughout the mixture. For use in the procedures described herein the typical quantity of the uncured coating formulation prepared at one time was 100 grams total weight. The uncured coating formulation was then applied by spatula to a grit-blasted surface of a rectangular test coupon or u-bend. For the rectangular test coupon, a doctor blade was passed across the surface of the uncured coating formulations to achieve uniform thickness of 25-30 mils For the test u-bends, a weighed quantity of the uncured coating formulation corresponding to the desired thickness was spread over the grit blasted area using a spatula. Coated test samples were cured at 20 degrees Centigrade (° C.) for 1 day prior to submission for testing.

### Method 2 Single Amine Uncured Coating Formulation

The uncured coating formulation was prepared in the same fashion as the BELZONA control uncured coating formulation with the difference being that the dual-amine was replaced by the equivalent weight of a single amine, cyclohexanediamine (herein designated CHDA, also designated Diaminocyclohexane or DACH in the literature). The details of mixing and application to the test sample coupons and u-bends are identical to those used for the BELZONA control. Samples were cured for 3 hours at 50 degrees Centigrade in air in a convection oven, followed by 20 hours at 20 degrees Centigrade, prior to submission for testing.

### Method 3 Single Amine Low-Filler Uncured Coating Formulation

The epoxy fraction of the B1591 resin/filler blend was isolated by adding an equal volume of acetone to the resin/filler blend, stirring until the resin/filler was suspended, then allowing the mixture to sit overnight at ambient temperature (20 degrees Centigrade). The mixture was then centrifuged at 2000 rpm for 1 hour, after which a first liquid layer consisting primarily of acetone, was decanted away from a second liquid layer comprising the resin and acetone and a third solid layer consisting primarily of the filler. This second layer could be removed from the centrifuge tube using a spatula. Some of the smaller particles from the filler were included in this resin fraction. This resin fraction was then blended by hand with cyclohexanediamine (CHDA) in ratio of 8.6 parts resin fraction to 1 part CHDA by weight. The mixture was applied to the grit-blasted surfaces of the rectangular test coupons and u-bends in the same fashion as discussed above for the BELZONA control. Samples were then cured for 3 hours at 50 degrees Centigrade (° C.) in air in a convection oven, followed by 20 hours at 20 degrees Centigrade, prior to submission for testing.

### (2) Coating Formulations and Application Protocols

For steam out and H₂S resistance testing, samples in two geometries were prepared using four coating formulations. C1018 steel 2 inch×4 inch coupons each comprising a center of coupon weld line were coated on the weld line side to a nominal thickness of 30-40 mils for steam out testing at 420 degrees Fahrenheit (° F.).

U-bend samples of A387 (2.25 Cr-1 Mo) steel for H₂S resistance testing were coated on the outer (tensile) surface to a thickness on the order of 30-40 mils, and protected on the inner compressive surfaces and edges by application of a standard barrier coating. For all samples, the surfaces on which the uncured coating formulations were applied were first cleaned by grit blasting with 24-size grit and degreasing, prior to the application of the uncured coating formulation. The dimensions of the coated surface were approximately 1 inch by 2 inches in area.

Cured coatings were prepared from four uncured coating formulations and cured as indicated below: (Comparative Example 1) the BELZONA 1591 control uncured coating formulation (described in Method 1 above), comprising the standard BELZONA 1591 resin-filler mixture and the standard DETA/CHDA amine curing agent mixture, was cured at ambient temperature (20° C.) for 1 day; (Comparative Example 2) the BELZONA 1591 uncured coating formulation from which a majority of the solid filler had been removed (described in Method 3) above was cured using the standard DETA/CHDA amine mixture at ambient temperature (20° C.) for 1 day; (Example 1) the BELZONA 1591 uncured coating formulation containing the standard amount of filler and containing CHDA amine only as the curing agent was cured at 50° C. for 3 hours; and (Example 2) the BELZONA 1591 uncured coating formulation from which a majority of the solid filler had been removed (as described in Method 3 above) comprising CHDA amine only as the curing agent was cured at 50° C. for 3 hours.

The filler-free uncured coating formulations were prepared and tested to determine the effect of filler on cured coating performance in a steam-out test environment and a hydrogen sulfide (H₂S) test environment. The CHDA-only uncured coating formulations were prepared and tested to compare coating performance against that of the BELZONA control, again in two environments. Tables 1 and Table 2 below list the coatings applied to the two sample geometries, Test Coupons, Table 1, and U-bends Table 2. With respect to the Table 1, each of the 2 inch by 4 inch coupons had an upper surface area of 8 square inches which was entirely coated with the uncured coating formulation. Three replicate coated coupons were made for each formulation. Table 1 shows the total weight and density of each formulation used. In each case the total volume of the uncured coating formulation was 7.87 cm³. Each coated sample had a calculated coating thickness of 0.02 inches, (7.87 cm³/16.387 cm³/in³=0.48 in³, divide by 3 coupons=0.16 in³ per coupon, divided by the coated surface area of the coupon 8 in²=0.02 inch coating thickness). Two of the three replicate coupons coated with each formulation were tested in the steam-out test and one was tested in the H₂S test.

TABLE 1
Test Coupons

| | Uncured | Total | | | |
|---|---|---|---|---|---|
| | Coating | Weight of | | | |
| | Formulation | Formula- | Steam- | | |
| 2″ × 4″ | density | tion | out | H₂S | Coating |
| Coupons | (g/cc) | used (g) | Test | Test | Appearance |
| Comparative | 1.9 | 14.95 | 2 | 1 | Black, |
| Example 1 | | | | | Smooth |
| Comparative | 1.2 | 9.44 | 2 | 1 | Brown, rough |
| Example 2 | | | | | surface, |
| | | | | | aggregates |
| Example 1 | 1.9 | 14.95 | 2 | 1 | Black, Smooth |
| Example 2 | 1.2 | 9.44 | 2 | 1 | Brown, very |
| | | | | | rough surface, |
| | | | | | aggregates |

Table 2 shows the total weight and density of each formulation used. In each case the total volume of the uncured coating formulation was 1.31 cm³. Each coated U-bend sample had a calculated coating thickness of 0.02 inches, (1.31 cm³/16.387 cm³/in³=0.08 in³, divide by 2 U-bends=0.04 in³ per U-bend sample, divided by the coated surface area of the U-bend sample 2 in²=0.02 inch coating thickness). Two replicate U-bends coated with each formulation were tested in the H₂S test. The coating formulations employed correspond as follows to those shown in Table 1: the coating formulation of Comparative Example 3 corresponds to the coating formulation of Comparative Example 1; the coating formulation of Comparative Example 4 corresponds to the coating formulation of Comparative Example 2; the coating formulation of Example 3 corresponds to the coating formulation of Example 1; and the coating formulation of Example 4 corresponds to the coating formulation of Example 4.

TABLE 2
Test U-Bends

| | Uncured | Total | | | |
|---|---|---|---|---|---|
| | Coating | Weight of | Coating | | |
| | Formulation | Formula- | Thick- | | |
| | density | tion | ness | H₂S | Coating |
| U-bends | (g/cc) | used (g) | (inches) | Test | Appearance |
| Comparative | 1.9 | 2.49 | 0.02 | 2 | Black, |
| Example 3 | | | | | Smooth |
| Comparative | 1.2 | 1.57 | 0.02 | 2 | Brown, rough |
| Example 4 | | | | | surface, |
| | | | | | aggregates |
| Example 3 | 1.9 | 2.49 | 0.02 | 2 | Black, Smooth |
| Example 4 | 1.2 | 1.57 | 0.02 | 2 | Brown, very |
| | | | | | rough surface, |
| | | | | | aggregates |

### (3) Performance of Coatings

Two types of testing were performed to evaluate coating performance. Steam Out testing (“Steam Out Test”) was conducted at 420° F. (216° C.) for five periods of one week each. Hydrogen embrittlement testing (“H₂S Test”) was conducted according to NACE TM0177 using Solution A—Method C of that standard, which is a mixture of 5% NaCl with 0.5% acetic acid having pH of approximately 2.7, saturated with H2S at ambient temperature. H₂S Test substrates were welded ASTM G30 U-bends comprised of 2.25 Cr 1 Mo low alloy steel.

Test samples for steam out testing were C1018 steel coupons having dimensions 2 inch×4 inch comprising a mid-coupon weld line. The samples were coated on the weld line side to a nominal thickness of 30-40 mils Steam out tests were carried out in a 4 liter Hastelloy autoclave containing 240 cc de-ionized water. The autoclave was heated using resistance heating coils to 365 or 420 degrees Fahrenheit (216 degrees Centigrade). Eight coated test coupons were mounted vertically in the unit, each sample placed between two PTFE discs supported by stainless steel mesh. The steam out test was run for five weeks total time, a period equivalent to twenty years field service. During the steam out test, heating was discontinued periodically and the test samples examined visually every week during the five week exposure period. The test coupons were tested as coated, with no masking, and surface scratches were not covered.

U-bends consisting of 2.25 Cr 1 Mo low alloy steel formed into a u-shape and held under stress by a bolt & nut combination, were coated on the outer, i.e., tensile side with various coatings. Shellac was used to coat the edges and inner surface of the u-bends to prevent crack initiation in these areas. All samples were tested using the NACE (National Association of Corrosion Engineers) specification TM0177 protocol, which calls for immersion of samples in a test solution of 5% NaCl+ and 0.5% acetic acid, which is de-aerated and then saturated with 100% H2S, at ambient temperature. The initial pH of the test solution was 2.7 and the final pH was 4.0. The total solution volume was about six liters. Saturation of the test solution by hydrogen sulfide was maintained by continuously sparging the solution with 100% hydrogen sulfide gas (continuous flow). The test was conducted at ambient temperature for a 4-week period. 10 U-bend specimens were immersed in the test solution and exposed simultaneously to the hydrogen sulfide saturated test solution over the four-week test period.

Steam out tests conducted at higher temperature (420° F.) showed a greater degree of coating degradation than that observed at a lower test temperature (365° F.). All of the organic coatings exhibited some discoloration, some blistering and cracking. Examination of coating cross sections showed that 1) the organic coatings without the oxide filler did not perform as well as those with the filler, 2) Some of the coatings developed voids during the steam out test, perhaps due to decomposition of the organic resin or leaching of filler from the coating. It is believed that such voids may facilitate steam coming into contact with the underlying steel substrate in the heat affected zone around the weld line covered by the coating.

In the hydrogen embrittlement tests, a first uncoated control sample (not listed in Table 2), a naked as-welded specimen, exhibited significant cracking; and a second control sample (not listed in Table 2), a naked grit blasted specimen, exhibited cracking along the line of the weld on the outer (tensile) surface of the sample). Comparative Example 3, the Belzona B1591 control comprising the filled B1591 resin combined with the standard dual amine package as supplied by the manufacturer, exhibited no cracking. In Comparative Example 4, a U-bend test sample coated with unfilled B1591 resin together standard dual amine package as supplied by the manufacturer, exhibited cracking. In Example 3 and Example 4 no cracking was observed for samples prepared according to the method provided by the present invention. It is significant that the presence of filler was not critical to crack prevention in the hydrogen embrittlement test when the coatings were applied according to one or more embodiments of the present invention.

The data presented in this disclosure point to various advantages provided by the present invention. Because the uncured coating formulations are free of aggressive curing agents such as DETA, the enhanced pot life of the uncured coating containing the vicinal primary diamine curing agent with or without the oxide filler allows for greater latitude in scheduling the preparation of the coating formulation itself and its application to surfaces to be protected. In addition, because coatings prepared using the method of the present invention have been shown to be effective for certain applications, with or without added filler, it is possible in some embodiments to apply the uncured coating to the surface to be protected using a brush rather than a trowel or other tool used for applying highly viscous materials.

The foregoing examples are merely illustrative, serving to illustrate only some of the features of the invention. The appended claims are intended to claim the invention as broadly as it has been conceived and the examples herein presented are illustrative of selected embodiments from a manifold of all possible embodiments. Accordingly, it is Applicants' intention that the appended claims are not to be limited by the choice of examples utilized to illustrate features of the present invention. As used in the claims, the word “comprises” and its grammatical variants logically also subtend and include phrases of varying and differing extent such as for example, but not limited thereto, “consisting essentially of” and “consisting of.” Where necessary, ranges have been supplied, those ranges are inclusive of all sub-ranges there between. It is to be expected that variations in these ranges will suggest themselves to a practitioner having ordinary skill in the art and where not already dedicated to the public, those variations should where possible be construed to be covered by the appended claims. It is also anticipated that advances in science and technology will make equivalents and substitutions possible that are not now contemplated by reason of the imprecision of language and these variations should also be construed where possible to be covered by the appended claims.

What is claimed is:

1. A method of protecting refinery equipment, the method comprising:
(a) applying an uncured organic coating comprising a curable epoxy phenol novolac resin and a curing agent comprising a vicinal primary diamine moiety to a surface of refinery equipment susceptible to corrosion; and
(b) curing the uncured coating to form a cured coating having a viscosity of at least 2,000,000 centipoise;
wherein the uncured organic coating has a viscosity of less than 500,000 centipoise, and
wherein the uncured coating is substantially free of components comprising secondary and tertiary amine groups, and
wherein the uncured coating is characterized by a latent viscosity of at least 2,000,000 centipoise when cured for 1 hour at 50° C.

2. The method according to claim 1, wherein said surface is subjected to a surface cleaning step prior to step (a), and wherein said surface cleaning step comprises grit blasting the surface to a white metal finish having a root mean square surface roughness of at least 3 thousandths of an inch.

3. The method according to claim 2, wherein said grit blasting is conducted with 24-grit alumina particles.

4. The method according to claim 1, wherein the surface susceptible to corrosion comprises a heat affected zone around a weld line.

5. The method according to claim 1, wherein said uncured organic coating is prepared by combining and mechanically mixing a first component curable epoxy novolac resin and a second component curing agent comprising a vicinal primary diamine moiety, said first and second components being components of a coating kit.

6. The method according to claim 5, wherein the curable epoxy novolac resin and the curing agent are mixed in a weight ratio of from about three parts by weight to about twelve parts by weight of the curable epoxy phenol novolac resin to one part by weight of the curing agent.

7. The method according to claim 1, wherein the uncured organic coating has a viscosity of less than 200,000 centipoise.

8. The method according to claim 1, wherein applying the uncured coating to the surface comprises a brush-on application.

9. The method according to claim 1, wherein applying the uncured coating to the surface comprises a spray-on application.

10. The method according to claim 1, wherein said curing is carried out at a temperature in a range from about 20° C. to about 60° C.

11. The method according to claim 1, wherein said curing comprises contacting the uncured coating disposed on the surface with a stream of air having a temperature in a range from about 30° C. to about 60° C.

12. The method according to claim 1, wherein said cured coating is characterized by an average thickness in a range from about twenty thousandths of an inch to about thirty thousandths of an inch.

13. The method according to claim 1, wherein the uncured organic coating comprises a solvent.

14. The method according to claim 1, wherein the uncured organic coating is solvent free.

15. The method according to claim 1, wherein the uncured organic coating comprises a filler.

16. The method according to claim 15, wherein said filler comprises zinc oxide.

17. The method according to claim 1, wherein the curing agent has structure I 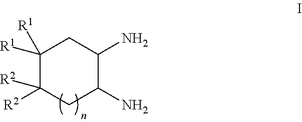
wherein n is 0, 1, 2, or 3 and R¹ and R² are independently at each occurrence hydrogen, a primary amine moiety, a C₁-C₁₀ aliphatic radical, a C₄-C₁₀ cycloaliphatic radical, a C₆-C₁₀ aromatic radical, or R¹ and R² may together form a second ring.

18. The method according to claim 1, wherein the curing agent is cyclohexane-1,2-diamine.

19. A method of protecting refinery equipment, the method comprising:
(a) applying an uncured organic coating to a surface of refinery equipment susceptible to corrosion, said uncured organic coating comprising a curable liquid epoxy phenol novolac resin and a curing agent comprising a vicinal primary diamine having structure I 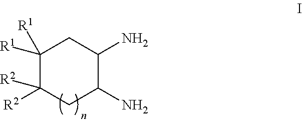
wherein n is 0, 1, 2, or 3 and R¹ and R² are independently at each occurrence hydrogen, a primary amine moiety, a C₁-C₁₀ aliphatic radical, a C₄-C₁₀ cycloaliphatic radical, a C₆-C₁₀ aromatic radical, or R¹ and R² may together form a second ring; and
(b) curing the uncured coating at a temperature in a range from about 20° C. to about 60° C. to form a cured coating having a viscosity of at least 2,000,000 centipoise;
wherein the uncured coating is substantially free of secondary and tertiary amine groups, and
wherein the uncured coating is characterized by a latent viscosity of at least 2,000,000 when cured for 1 hour at 50° C.

20. A method of protecting refinery equipment, the method comprising:
(a) applying an uncured organic coating to a surface of refinery equipment susceptible to corrosion, said uncured organic coating comprising a curable liquid epoxy phenol novolac resin and a curing agent comprising structure II 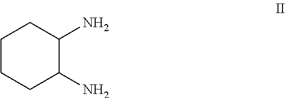
wherein said surface comprises a weld line and is characterized by a mean square surface roughness of at least 3 thousandths of an inch; and
(b) curing the uncured coating at a temperature in a range from about 20° C. to about 60° C. to form a cured coating having a viscosity of at least 2,000,000 centipoise;
wherein the uncured coating is substantially free of secondary and tertiary amine groups, and
wherein the uncured coating is characterized by a latent viscosity of at least 2,000,000 when cured for 1 hour at 50° C.

21. A method of protecting a refinery vessel, the method comprising:
(a) grit blasting a refinery vessel surface comprising a weld line to achieve a root mean square surface roughness of at least 3 thousandths of an inch;
(b) combining a curable liquid epoxy novolac resin with a curing agent comprising structure II 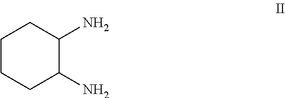
to provide an uncured organic coating having a viscosity of less than 200,000 centipoise;
(c) applying the uncured coating to the refinery vessel surface grit blasted in step (a); and
(d) curing the uncured coating at a temperature in a range from about 40° C. to about 60° C. over a time period ranging from about 1 hour to about 4 hours to form a cured coating having a viscosity of at least 2,000,000 centipoise;
wherein the uncured coating is substantially free of secondary and tertiary amine groups, and
wherein the uncured coating is characterized by a latent viscosity of at least 2,000,000 when cured for 1 hour at 50° C.
